(19) United States
(12) Patent Application Publication
(10) Pub. No.: US 2018/0116460 A1
(43) Pub. Date: May 3, 2018

(54) VESSEL SYSTEM, METHOD, AND DEVICE FOR AUTOMATICALLY PROVIDING A FOOD PREPARATION

(71) Applicant: Arrola AG, Balzers (LI)

(72) Inventor: Bruno FOSER, Balzers (LI)

(21) Appl. No.: 15/561,818

(22) PCT Filed: Mar. 27, 2015
(86) PCT No.: PCT/EP2015/056714

§ 371 Date: Sep. 26, 2017

(51) Int. Cl. A47J 41/00

(52) U.S. Cl. CPC A47J 41/0077; A47J 41/0061

(57) ABSTRACT

The invention relates to a vessel system (10), a machine, and a method for providing a freshly-prepared food preparation, said vessel system (10) comprising at least one outer sheath (24) and one storage vessel (16), and said food preparation comprising at least one foodstuff in the form of an ingredient (12) and one additional foodstuff (14), the ingredient (12) being provided in a filled storage container (16) sealed with cover foil (26), and this being merged with said outer sheath (24) to form a serving container (10′).

The invention presented here is concerned with the automatic dispensing of meals to a user put together from multiple foodstuffs, in particular of food preparations where the temperatures differ considerably from the ambient temperature, that is to say are very warm or hot or very cold, and in particular also with the automatic preparation of ingredients for such types of meals or food preparations.

EP 2 316 308 and EP0729312 disclose devices for intermittently cooking and preparing portioned foodstuffs, in particular pieces of food such as, for example, pasta products, rice, pieces of meat or fish. After the cooking process, the cooked products are delivered onto or into a container such as, for example, a plate, a bowl or a cup, the container being prepared either by the automatic machine or by the user or at least being placed under the dispensing opening of the device.

In order to obtain a finished dish, ready-made sauces packed in pouches, which can be poured over the hot pieces of food, are as a rule provided next to such an automatic cooking appliance. As a result of being mixed with the hot pieces of food, the sauce is heated, and the user thus obtains a ready-made hot meal which is intended for immediate consumption. Depending on the type of the pieces of food heated, the sauces can be simple tomato, cream or vegetable sauces or, however, also meat or fish sauces. For freshly cooked pieces of meat or fish, pouches with sauces which contain ready-cooked rice, cooked potato pieces etc. are also conceivable. Such pouches, as a rule, are realized in a similar manner as the generally known, small portion pouches for mustard, mayonnaise and ketchup or as cooking bags in which sauces can also generally be heated in a water bath and as are described for example in EP 2 671 719. Such pouches are, as a rule, perforated in a part region. The perforation is configured in a manner which, on the one hand, is to prevent material leaking from the interior of the pouch to the outside and, on the other hand, is nevertheless to enable the pouch to be opened along the perforation. The latter is, however, often difficult and as a rule requires two hands.

As the sauces and sometimes also the container for the dispensing of the cooked pieces of food are made available separately, said automatic cooking machines are also referred to as semi-automatic machines.

The disadvantage of the above-described semi-automatic machines is, on the one hand, that the container, from which the food preparation can be eaten, has to be provided in part or has to be placed under the output opening by the user himself, and, on the other hand, that the user, in order to pour the sauce onto his cooked pieces of food, has to put the container down so that he has two hands free in order to be able to open the pouch with the sauce. When opening the sauce pouch, there is additionally always a certain risk of soiling hands or even clothing with oozing or spraying sauce. Once the pouch has been emptied, the user has additionally to look for a waste bin in order to dispose of the pouch. Said aspects can stop many potential users from making use of the food available in such semi-automatic machines for example in their everyday working life.

It would be much more favorable, consequently, if such types of hot meals or food preparations, which include foodstuff freshly cooked in the automatic machine and at least one ingredient added to the cooked pieces of food, could be made available by a fully automatic machine; a fully automatic machine as is known, for example, for dispensing hot beverages. Along with the coffee powder and the hot water for brewing the coffee, such hot beverage or automatic coffee machines also provide the cup out of which the coffee can be drunk, as well as, where required, milk and/or sugar. The cups that are used in such automatic machines are as a rule configured in such a manner that they are easily stackable inside such a fully automatic machine. In an advantageous manner, they additionally comprise insulation such that the hot beverage remains hot in the cup and at the same time the user is protected from the unpleasant heat of the contents of the cup when he grips the cup. Such insulation can be present in the most varied forms, for example in the form of a cardboard sleeve fitted onto the cup or in the form of a polystyrene cup or in the form of fluting on the cup or on its outside.

Cup-like containers which can easily be stacked and comprise insulation are also described, for example, in EP 2 371 723 B1. They comprise an outer shell and a cup that is surrounded by the outer shell. Deformations are formed in a cup wall which stand out from the cup bottom, these being in the form of projections or shoulders that project into the interior of the cup and serve, when multiple of said cups are stacked, for holding one similar cup which is surrounded by an outer shell. The deformations formed in the cup can also serve, however, for holding a diaphragm or a lid or the like. The cup is formed from paper and, to stabilize the deformation in the region of the same, comprises an adhesive strip which is applied on the outside of the cup or a stabilizing plastic ring. The insulating outer shell, which is either only placed in position or is fixedly connected to the cup as an option, is provided in order to insulate the cup from the outside and to conceal the adhesive strip or the plastic ring. An air gap between cup and insulating outer shell is also provided as an option to improve the insulating effect of the outer shell, it also being possible to provide the cup with a radially outwardly directed deformation in order to ensure a defined distance between cup and outer shell. The cups described in EP 2 371 723 B1 consequently utilize the same effect as thermos flasks and similar double-walled warm-keeping vessels (cf. also EP 2 641 840) which, however, in contrast to the paper cups described in this document, are produced as a rule from glass or metal and, along with the double-walled, air-filled or gas-filled side walls, also comprise a double-walled, air-filled or gas-filled bottom.

Cups with outer shells, such as described in EP 2 371 723 B1, protect the user from the heat of the hot contents, and are consequently really suitable for hot low-viscosity beverages. They are, however, unsuitable for automatically dispensing cooked pieces of food with sauce that is rather viscous, as the inwardly projecting shoulders or projections favor sauce and pieces of food being left behind in the container and the configuration with outer shell and air gap increases the space required for stacking the cups, which is unfavorable for use in an automatic machine.

The object of the present invention, consequently, is to provide ingredients, such as for example sauces which are used, for example, in conjunction with an automatic cooking machine of the above-described type, in such a manner that the ready-made hot meals or food preparations produced from the freshly cooked foodstuffs and the ingredients can be made available in a fully automatic cooking machine. It is obvious, however, that instead of a portioned cooked, that is to say hot foodstuff, the dispensing of a very cold foodstuff such as, for example, ice cream with a chocolate, vanilla or fruit sauce, in particular also with a hot fruit sauce, would also be conceivable by means of such a fully automatic machine.

The present invention consequently includes a vessel system for storing an ingredient and for dispensing said ingredient together with further foodstuffs in a heated or cooled state to a user, the user being shielded from the temperature of the contents of the vessel system.

The vessel system includes an inner vessel with a fillable interior. In addition, it includes an outer shell which is realized to receive the inner vessel in such a manner that the outer shell insulates the contents of the inner vessel thermally from the outside. Outer shell and storage vessel are tapered downward, that is to say in the direction toward the bottom of the inner vessel. A particular characteristic of said vessel system is that the fillable interior of the inner vessel is sealingly closable in such a manner with a lid foil that the inner vessel forms, on the one hand, a tightly closable storage vessel for the storage of the ingredient and, on the other hand, multiple storage vessels are stackable as a result of placing them one on top of another. The advantage of said configuration is that the ingredient is storable in said storage vessel closed in an air-tight manner and is stackable in a space-saving manner. This is a great advantage in order to keep the ingredient, for example in the form of a ready-made sauce, available in an automatic machine in a space-saving manner for at least several days. In addition, the outer shell in said vessel system is an element that is separate from the storage vessel. It comprises at least one radially inward projecting clamping element, by way of which the storage vessel is fixable in the outer shell when received in the same. At the same time, the outer shell is configured tapering downward in such a manner that multiple outer shells are stackable nested inside one another.

The outer shell is advantageously configured in such a manner that multiple outer shells are stackable nested inside one another without being clamped by the at least one clamping element of the respectively receiving outer shell. It is ensured in this way that multiple outer shells are stackable nested inside one another in a space-saving manner and are also simple to separate out again. This is very advantageous in order to hold the outer shells in stock in a space-saving manner in an automatic machine.

As a result of the described configuration of the vessel system, it is possible to hold the storage vessels and the outer shells in stock separated from one another, for example in an automatic machine and only to put them together to form a dispensing container for dispensing to the user. The advantage of this is that different ingredients can be held in stock in the automatic machine and irrespective of the chosen ingredient, the dispensing container, which is formed out of the vessel system, is nevertheless always thermally insulated such that the user is protected from the temperature of the contents of the container and the contents of the container maintain their temperature for a long time. Compared to the storage of different ingredients in containers which are already surrounded by an insulating shell, the storage of the described vessel system manages with less space. In addition, the storage vessel itself does not comprise any deformations which would hold back the contents, but is nevertheless fixed well in the outer shell by the at least one clamping element of the same, which is very advantageous in particular for the use as is described further below.

If the at least one clamping element, matched to the height hg of the vessel shell of the storage vessel, projects inward from the inside of the outer shell in such a manner that, when the storage vessel is received in the outer shell, it cooperates in a clamping manner with the storage vessel in the top third of its vessel shell and fixes it, the storage vessel is embedded in a particularly stable manner in the outer shell. Instead of which or in addition to it, the clamping element can be configured and arranged such that, after the storage vessel is received in the outer shell, it protrudes radially inward beyond an upper vessel shell edge of the storage vessel above the storage vessel, more precisely when it projects radially at least into an axial projection of the vessel shell edge or its end face, and when it interacts in particular with the vessel shell edge (32) in the form of a snap mechanism.

The storage vessel comprises a vessel bottom and a vessel shell which stands out from the vessel bottom and has a height hg. The vessel shell is connected fixedly and tightly to the vessel bottom such that leakage of the ingredient, in particular even of a liquid ingredient, is reliably prevented. In a preferred embodiment, vessel shell and vessel bottom of the storage vessel are realized in one piece.

It is obvious that outer shell and storage vessel are produced from a dimensionally stable material, the outer shell being produced in particular from a biodegradable or at least easily recyclable material. The outer shell is preferably produced from an insulating material. This can be, for example, polystyrene or a foamed plastics material or—environmentally friendly corrugated cardboard or a biodegradable plastics material with air pockets. The storage vessel is preferably also produced from biodegradable material or at least from easily recyclable material. A vessel produced from aluminum can also be considered here. The lid foil of the storage vessel is advantageously formed from the same material as the vessel, namely, for example, from aluminum or just as preferably from a biodegradable material. It is obvious that only materials that are permitted for foodstuffs are used for the storage vessel and preferably also for the outer shell.

It is obvious that, for receiving the storage vessel, the outer shell comprises an inner width which is somewhat larger than the outer width of the storage vessel.

When the storage vessel is received in the outer shell, the outer shell surrounds the outside of the vessel shell of the storage vessel advantageously from the vessel bottom up to an upper edge of the vessel shell at the height hg. The thermally insulating effect of the outer shell is fully utilizable in this way.

On account of the tapering of outer shell and storage vessel being matched to one another and in particular stabilized by the at least one clamping element that projects into the interior of the outer shell, once the storage vessel has been received in the outer shell, there is a thermally insulating air gap between the outer shell and the storage vessel such that thermal insulation is obtained as a result of the air gap and the material of the outer shell itself does not necessarily have to have thermally insulating properties. Said effect is strengthened even more the more rigid the choice of material of the outer shell.

Outer shell and storage vessel preferably have a circular or polygonal outline as this is advantageous from a technical production point of view and is consequently cost-efficient.

In a particularly preferred embodiment, the storage vessel is dimensioned such that, in the filled state, it is filled with the ingredient up to its upper edge. In the case of identical quantities of ingredient, this means that the storage vessel can be dimensioned in a smaller manner, in particular, for example, the height hg of the vessel shell and/or the diameter can be chosen to be smaller. This saves space when storing the ingredients, when this is compared to the variant where the vessel shell projects far beyond the fill level of the ingredient. In the latter case, the excessive space could certainly be utilized for mixing ingredient and foodstuff.

In one embodiment, the outer shell protrudes upward beyond the vessel shell of the storage vessel beyond its height hg. This is particularly advantageous when the storage vessel is dimensioned small for the purpose of low expenditure on storage space and is filled up to its upper edge with an ingredient, for the space which is enclosed by the part of the outer shell projecting beyond the vessel shell edge is then utilizable as a mixing space for mixing the ingredient with a further foodstuff made available by the automatic machine.

In one embodiment, the at least one clamping element of the outer shell is configured such that it surrounds the vessel shell of the storage vessel in a sealing manner. The clamping element is realized for this purpose, for example, as a first circumferential, clamping sealing lip. The advantage of said configuration is that for the case where inadvertently or when mixing the ingredient with further foodstuffs, parts of the ingredient or of the further foodstuff leak over the edge of the storage vessel, they are caught on the sealing lip between outer shell and storage vessel.

In another embodiment, the at least one clamping element is realized in the form of multiple clamping lugs which are distributed over the periphery—preferably uniformly, the clamping lugs all being situated at an identical axial height or, however, being distributed over a certain axial expansion range. It is also conceivable for the clamping lugs to be distributed over the entire inner outer shell wall axially and in the circumferential direction. If the clamping lugs are distributed over the periphery and axially, there is a stable distance between outer shell and storage vessel and, independently of the rigidity of the material of the outer shell, there is a defined air gap between outer shell and storage vessel.

In a further embodiment, along with the first sealing lip, which extends around sealingly and clampingly in the upper third of the vessel shell of the storage vessel, there is a second sealing lip which extends around sealingly in the bottom third. A closed air gap with good thermal insulating properties is formed with the first and the second sealing lip between outer shell and storage vessel and,—when the second sealing lip also comprises clamping characteristics—compared to the variant with one sealing lip in the upper third, an even more stable embedding of the storage vessel in the outer shell is achieved. A third or further sealing lips or clamping lugs distributed freely axially and circumferentially are arranged between the first and the second sealing lip as an option. With the optional further sealing lips or clamping lugs, even where an outer shell is produced from less rigid material, it is ensured that when a user grips the vessel system, the outer shell is not pressed onto the vessel wall of the storage vessel and the thermally insulating air layer protecting the user remains stable even when accessed in the area of his fingers.

In a further variant, the outer shell is provided with a bottom and consequently forms an outer container which surrounds the bottom of the storage vessel and around the outside of the vessel shell. Even better thermal insulation of the contents from the outside is ensured in this way.

It is obvious that the air gap is kept as small as possible both laterally between storage vessel shell and outer shell and between vessel bottom and bottom of the outer shell so that the storage space required is as small as possible.

If the outer shell is provided with a bottom and therefore an outer container and if the clamping element is a sealing lip, the storage vessel has to be pressed into the outer shell/the outer container against a certain air resistance until it is fixed by the sealing lip and the forming air gap is tightly closed. Should then someone want to remove the storage vessel out of the outer container again, the resistance of building negative pressure has to be overcome. As a result of said effect, in the case of said embodiment, the storage vessel is fixed particularly securely and sturdily in the outer shell or outer container.

In order to make it possible, nevertheless, to remove the storage vessel out of the outer shell/outer container in the case of the previously described embodiment, the bottom of the outer container is configured in an advantageous manner such that it can be pressed-in in the middle and is pressable against the bottom of the storage vessel such that by means of said pressure, the storage vessel can be pressed out of the outer shell/outer container against the negative pressure.

In one embodiment, the vessel system includes a lid by way of which the vessel system is closable, it being closable with the lid preferably in a sealing manner.

The outer shell is advantageously configured on its upper edge in such a manner that it interacts sealingly with such a lid. Said embodiment makes it possible to transport the food preparation, removed from the automatic machine in the sense of a “take away”, hygienically packaged and thermally insulated, even when transported over longer distances. If the outer shell is additionally an outer container and/or the clamping element is a first sealing lip, the vessel system, with the tightly closed lid on the outer shell, can also be used for the mixing-by-shaking of the ingredient with the foodstuff or the further foodstuff(s).

For sealingly closing the fillable interior of the storage vessel, it advantageously comprises, on an end face of the vessel shell, an application surface on which the lid foil can be applied, i.e. is sealingly fixable. It is particularly advantageous when the end face of the vessel shell is widened for this purpose, for example as a result of a thickening of the vessel wall in its end-face end region or as a result of a radially protruding flange, for this results in having a larger application surface available for the applying of the lid foil, which has a positive effect on the tightness and the strength of the connection between lid foil and vessel shell.

The lid foil can preferably be applied as a result of bonding or welding or sealing.

In order to make the lid foil easily removable, it is advantageously provided with a grip tab which projects radially outward beyond the vessel shell or with a circumferential grip edge which projects radially outward.

An automatic machine, which serves for providing a food preparation which includes at least one foodstuff in the form of an ingredient and at least one further foodstuff, and in which the above-described vessel system according to the invention is used, comprises a depot for holding in stock a number of preferably different ingredients, which are stored in the described storage containers, and a storage unit for holding in stock a number of outer shells which are stacked inside one another. In addition, the automatic machine includes a device for separating-out and opening a selected storage vessel; a device for separating-out an outer shell from the stack of outer shells held in stock in the storage unit; a combining station in which one opened storage vessel each is inserted into a separated-out outer shell, as a result of which a dispensing container is formed out of the vessel system; and a transport device which feeds opened storage vessels and separated-out outer shells to the combining station; in addition, a foodstuff unit in which at least one further foodstuff is held in stock and, where applicable, is freshly prepared; as well as a feed device which feeds said at least one further foodstuff to the dispensing container with the ingredient situated therein, preferably in the combining station.

The number of outer shells which can be held in stock in the automatic machine, in particular in its storage unit, is advantageously at least the same or greater than the number of storage containers which are storable in the automatic machine, in particular in its depot, and which are filled with ingredients.

In one embodiment, the device for separating-out and opening a storage vessel comprises a gripper or lift mechanism for moving the lid foil or a separated part of the lid foil away. Grippers or lift mechanisms are in particular controlled by connecting links. In a further development, a disposal bin is provided in which the separated lid foil is disposable.

As an alternative to this, the disposal bin is a container which is separate from the automatic machine and is connectable in such a manner to the automatic machine that all waste occurring in the automatic machine can be disposed of therein.

The combining station advantageously includes a holder, by means of which the outer shell is holdable in position, it also being possible for said holder to be a component part of the transport device which feeds the outer shell to the combining station. In addition, the combining station advantageously includes a punch-like element, by way of which the storage vessel is placeable in the outer shell in a precisely fitting manner and, where applicable, against the resistance of the at least one clamping element.

In one embodiment, a store for the lids is integrated in the automatic machine, by way of which lids the dispensing containers, formed from outer shell and storage vessel, are closable. So that the user, where required, can obtain a lid, the store is either accessible to the user in such a manner that he is able to remove a lid in each case out of the store either by hand himself or a lid is automatically dispensed out of the store. The latter can be effected either on request or automatically with the dispensing of each food preparation in a dispensing container.

In a further embodiment, along with the store for lids, a device is provided for closing the dispensing container with a lid. In a further development of said embodiment, a shaking device is additionally provided, by means of which shaking device the dispensing container, which is closed by way of the lid, can be shaken, in particular up and down, that is to say in the direction of the bottom and of the lid, in order to mix the supplied at least one further foodstuff with the ingredient already situated in the dispensing container.

A device for preparing and cooking portioned, cooked pieces of food can be provided as a foodstuff unit, as is described, for example, in EP 2 316 308.

As a result of the vessel system according to the invention, the possibility is provided of keeping a greater number of thermally insulating outer shells in stock in the automatic machine separately from the storage vessels with the ingredients. As a result, it is now possible to keep storage vessels with different ingredients in stock in the automatic machine such that the user can choose, for example, between different sauces to go with his freshly cooked pasta products. Whilst the pasta products are subject to the cooking process, a storage vessel filled with the ingredient chosen by him is made available from the store of ingredients and is opened by removal of the lid foil. At the same time, an outer shell is separated-out from the stack of outer shells and made available. The opened storage vessel is placed in the outer shell and fixed in the outer shell by means of the at least one clamping element of the outer shell. The ready-cooked pasta products are added, and the vessel system with the ready-made hot meal can be removed from the automatic machine.

The vessel system according to the invention and the method or the associated automatic machine are described in more detail below by way of exemplary embodiments shown in the figures. The explanations are given only as an example and have no restricting effect. Identical elements in the figures are designated with identical reference numbers. The figures are not true to scale, individual elements can be shown in a disproportionate manner for the purposes of better visibility. The vessel system or its individual components are generally shown in the following figures in section along the longitudinal axis of the vessel system. The figures are purely schematic representations as follows:

FIG. 1 shows a first embodiment of a vessel system according to the invention with an outer shell and a storage vessel;

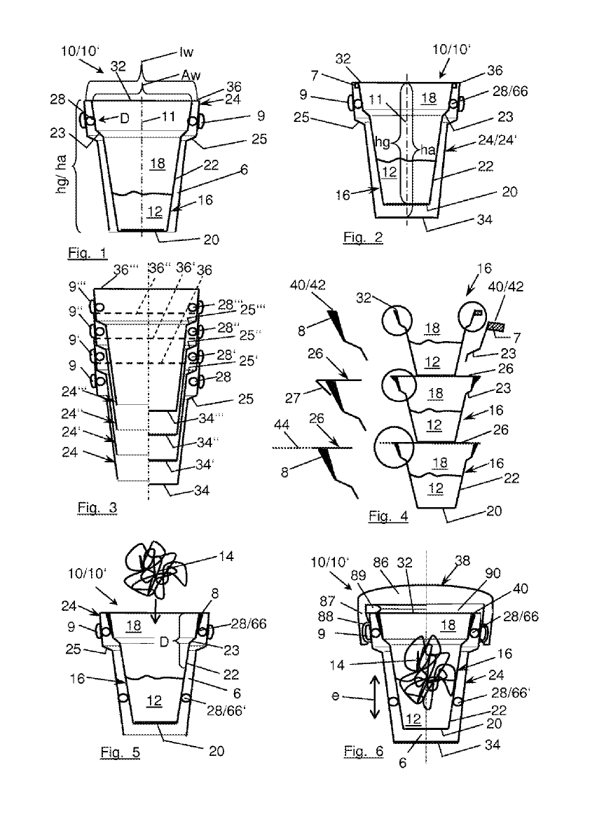

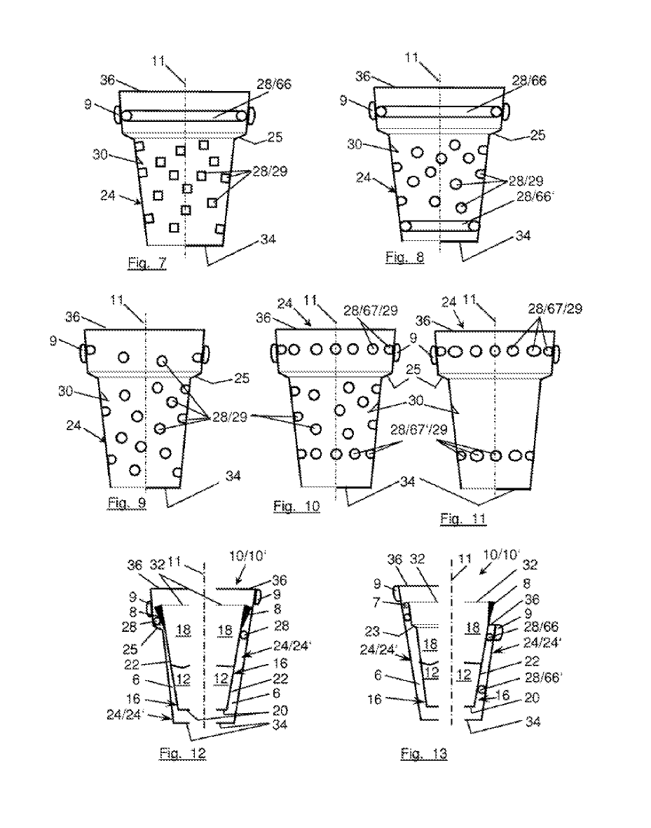

FIG. 2 shows a second embodiment of the vessel system;

FIG. 3 shows multiple outer shells of the embodiments of the vessel system shown in FIG. 1 or FIG. 2 stacked inside one another;

FIG. 4 shows multiple storage vessels of the embodiments of the vessel system shown in FIG. 1 or FIG. 2 provided with a lid foil and stacked standing one on top of the other, individual aspects being shown enlarged in the associated representations of the detail;

FIG. 5 shows a further embodiment of the vessel system with an ingredient in the storage vessel, the vessel system just being filled with a further foodstuff;

FIG. 6 shows another embodiment of the vessel system, this one being shown closed by way of a lid with an ingredient and a further foodstuff in the storage vessel;

FIGS. 7 to 13 show different embodiments of outer shells for the vessel system according to the invention;

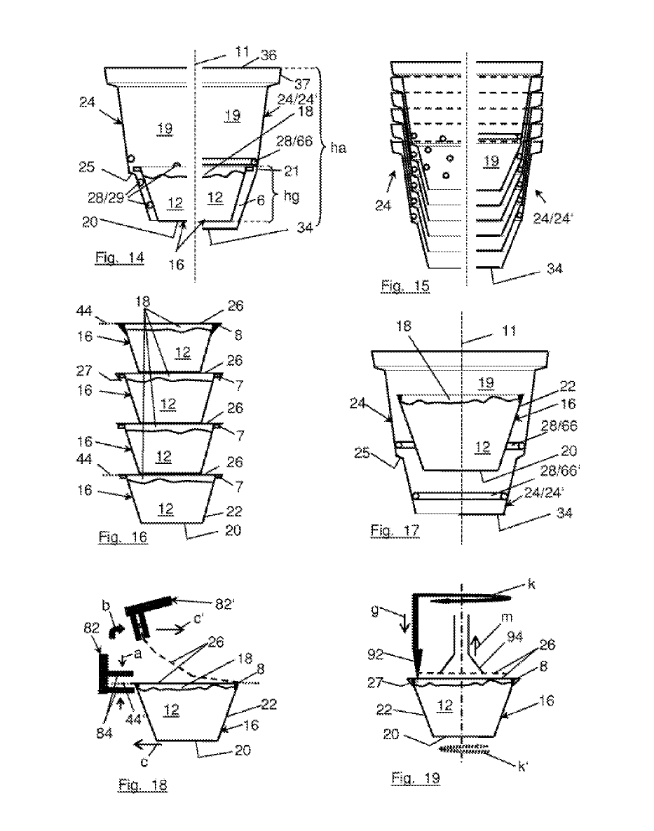

FIG. 14 shows a further embodiment of the vessel system;

FIG. 15 shows multiple outer shells of the vessel system shown in FIG. 13 stacked inside one another;

FIG. 16 shows multiple storage vessels of the vessel system shown in FIG. 13 provided with a lid foil and stacked standing one on top of another;

FIG. 17 shows a further embodiment of the vessel system;

FIGS. 18 and 19 show two examples of the automated opening of a storage vessel or the automated removal of the lid foil from a storage vessel;

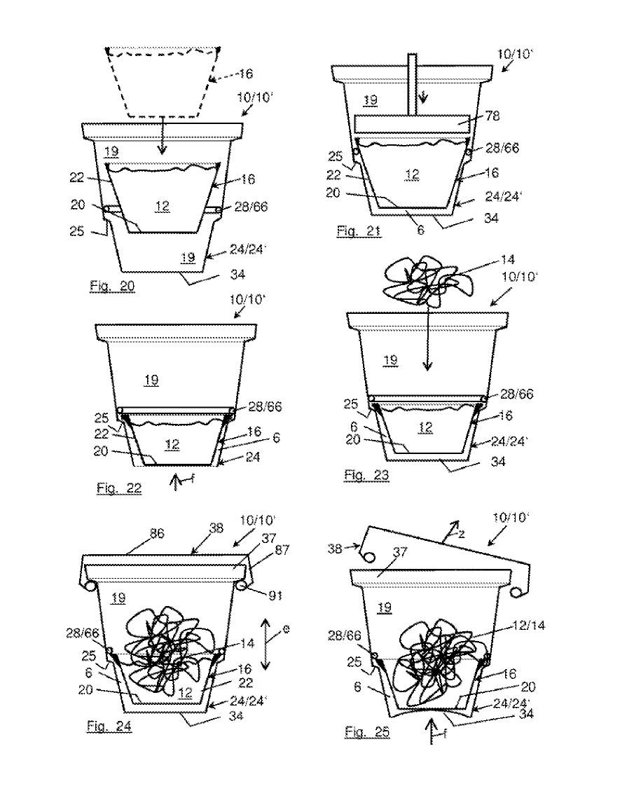

FIGS. 20 to 25 show method steps for the automated provision of a meal including a foodstuff in the form of an ingredient and at least one further foodstuff by means of the vessel system according to the invention;

FIG. 26 shows an automatic machine for the automated provision of a meal including a foodstuff in the form of an ingredient and at least one further foodstuff by means of the vessel system according to the invention.

First of all, the vessel system 10 according to the invention is explained in more detail by way of FIGS. 1 to 12. The vessel system 10 or its different component parts, such as in particular outer shell 24 and storage vessel 16, are as a rule shown in section along a longitudinal axis 11. The outline can be a circle, an oval or a polygon, the outline of outer shell 24 and of storage vessel 16 as a rule being in the same form. However, they are configured in each case matched to one another at all times such that the storage vessel 16 is received by the outer shell 24 and is fixable in it.

FIG. 1 shows a sectional representation along its longitudinal axis 11 of a first embodiment of the vessel system 10 according to the invention which also serves as a dispensing container 10′ for the dispensing of a food preparation which includes at least one ingredient 12 and one further foodstuff 14. The vessel system 10 includes an outer shell 24 with a height ha and an inwardly projecting clamping element 28 as well as the storage vessel 16 which is shown here already received in the outer shell 24.

The storage vessel 16 serves for receiving and storing a first foodstuff which is present in the form of an ingredient 12 and in particular, for example, in the form of a sauce. The storage vessel 16 includes a vessel bottom 20 and a vessel shell 22, which protrudes from said vessel bottom and has a vessel shell height hg which, in said example, is identical to the shell height ha of the outer shell 24. In order to be able to receive the storage vessel 16 in the outer shell 24, the outer shell 24 comprises an inner width Iw which is greater than the outer width Aw of the storage vessel 16. Outer shell 24 and storage vessel 16 are tapered downward, this means toward the vessel bottom 20, it being possible for the tapering to be realized constantly and/or sudden taperings in the form of vessel shoulders 23 (storage vessel 16) or shoulders 25 (outer shell 24) can be provided.

Storage vessel 16, outer shell 24 and clamping element 28 of the outer shell 24 are realized matched to one another in such a manner that in the combined state, the clamping element 28 cooperates clampingly with the storage vessel 16 in its upper third D and fixes it in the outer shell 24. In this connection, an air gap 6 is as a rule formed between outer shell 24 and vessel shell 22 of the storage vessel 16. As the outer shell 24 in the example shown here does not have a bottom and the air gap is consequently not closed in relation to the surrounding air, the air gap 6 here only has a limited thermal insulating effect. In the case of such a design, the outer shell is itself produced in an advantageous manner from a material with good thermal insulation such as, for example, from a foamed plastics material or corrugated cardboard or the like. The upper vessel edge 32 of the storage vessel 16 and the upper edge 36 of the outer shell 24 close off flush with one another in the combined state in the example shown here, it is also conceivable for the vessel edge 32 to extend beyond the upper edge 36 of the outer shell 24 or in reverse, the upper edge 36 of the outer shell 24 to extend upward beyond the upper vessel edge 32 of the storage vessel 16, as is shown, for example, in FIGS. 12, 13 and 14. So that the vessel system 10 is able to stand solidly, the outer shell 24, when it does not have a bottom as shown in FIG. 1, closes off at its lower end flush with the vessel bottom 20 of the storage vessel 16 or is a little shorter than the vessel shell 22 of the storage vessel 16.

FIG. 2 shows an embodiment of the vessel system 10 which is realized identically to that shown in FIG. 1, only in this case the height ha of the outer shell 24 is somewhat greater than the shell height hg of the vessel shell 22 of the storage vessel 16. The outer shell 24, in this example, is closed off at the bottom with a bottom 34 such that in this case the outer shell 24 forms an outer container 24′. The air gap 6 existing in the combined state between outer shell 24 and vessel shell 22 of the storage vessel 16 also exists in this case between the vessel bottom 20 of the storage vessel and the bottom 34 of the outer shell 24. It is closed off at the top all around against the surrounding air by the clamping element 28, which is realized as sealing lip 66, and develops its full thermally insulating effect in this way. In addition, the air gap 6 is also more stable in this way in the sense that when the vessel system 10 is gripped, the outer shell 24 cannot be pressed so easily against the vessel shell 22 of the storage vessel 16 against the resistance of the air gap 6.

FIG. 3 shows multiple outer shells 24, 24′, 24″, 24′″ as are already shown in FIG. 1 or FIG. 2 stacked inside one another. In this case, the outer shells 24, 24′, 24″, 24′″ on the left-hand side are shown without bottoms and on the right-hand side in each case with bottoms 34, 34′, 34″, 34′″. As can easily be seen from FIG. 3, the outer shells 24, 24′, 24″, 24′″, in the upper region below the clamping element 28, 28′, 28″, 28′″, comprise sudden tapering in the form of a shoulder 25. In addition, an outwardly projecting projection 9, 9′, 9″, 9′″ is provided on the outside of the outer shells in each case approximately at the height of the clamping element 28, 28′, 28″, 28′″. Said projection 9, 9′, 9″, 9′″ can be realized as a circumferential grip edge or can be in the form of individual protrusions distributed over the periphery. When the outer shells 24′″, 24″, 24′, 24 are stacked inside one another, in the example shown here in each case the projection 9′″ or 9″ or 9′ of the inserted outer shell 24′″, 24″, 24′ sits on the upper edge 36″ or 36′ or 36 of the outer shell 24″, 24′, 24 situated below it and thus prevents the inserted outer shell 24′″ or 24″ or 24′ sliding any deeper. The shoulder 25′″,25″, 25′, 25, which is situated under the clamping element 28′″, 28″, 28′, 28 of each outer shell 24′″, 24″, 24′, 24, similarly ensures that the inserted outer shell 24′″, 24″, 24′ is not clamped by the outer shell 24″, 24′, 24, situated below it by way of the clamping element 28″ or 28′ or 28 thereof. As a result of said configuration, it is possible to stack the outer shells 24, 24′, 24″, 24′″ inside one another in a space-saving manner and to separate them out into singles again without any effort. It is obvious that other designs of the outer shell with the same effect are also advantageously usable.

FIG. 4 shows multiple storage vessels 16, as have already been disclosed in principle in FIGS. 1 and 2, however they are configured differently in each case in their detail in order to illustrate a selection of different configuration possibilities which is in no way final. The bottom two storage vessels 16 are each shown closed at the top with a lid foil 26. The lid foil 26 closes an interior 18 of the storage vessel 16, which is surrounded by vessel bottom 20 and vessel shell 22, in an air-tight manner from the outside and consequently makes it possible to store the ingredient 12 in the storage vessel 16 for a longer period, that is to say for at least between 2 and 10 days in the storage vessel 16, without any risk of spoiling. The lid foil 26 is formed from very sturdy material and is fixed, for example as a result of bonding, welding or sealing, on the upper vessel edge 32 of the respective storage vessel 16 in such a good manner that—as shown—multiple storage vessels 16 can easily be placed one on top of another and stacked in this way.

The upper vessel edge 32 is realized in FIG. 1 without any thickening or similar. For a simpler and sturdier application of the respective lid foil 26, however, it is advantageous when the vessel shell 22 is either configured thickened towards the top (thickening 8) or is widened by a flange 7 which preferably protrudes outward. A widened application surface 42, on which the lid foil 26 is fastenable, is obtained on the upper end face 40 of the vessel shell 22 in this way. The lid foil 26 can also be bent over about the upper vessel edge 32 instead of being applied only onto said end face 40. The bend 27 formed in this manner can also be fixed laterally on the outside of the vessel shell 22 as an option. In order also to be able to remove the lid foil 26 simply again when required, it is possible to configure the lid foil 26 with a grip tab 44 or a circumferential grip edge (reference 44′ in FIG. 18) which projects radially outward.

As already mentioned above, the vessel system 10 is intended to serve as a dispensing container 10′ for the dispensing of a food preparation which is composed of at least one foodstuff in the form of the ingredient stored in the storage vessel 16 and one further foodstuff 14, the food preparation comprising, in particular, a temperature that deviates strongly from the ambient temperature, that is to say is either very warm or hot or, however, very cold. Which is why a closed air gap 6 and good fixing of the storage vessel 16 in the outer shell 24 is particularly advantageous.

FIG. 5 shows a further embodiment of the vessel system 10, the storage vessel 16 being shown open as in FIGS. 1 and 2, that is to say without any lid foil 26, and properly fixed in the outer shell 24 by means of the clamping element 28 of said outer shell. The embodiment shown here differs from the embodiment shown in FIG. 1 in that two circumferential sealing lips 66, 66′ are provided as clamping element 28, the first, upper sealing lip 66 cooperating with and fixing the storage vessel 16 in its top third D, as the clamping element in FIG. 1 also does. The second, lower sealing lip 66′, in contrast, cooperates with the storage vessel 16 in its bottom half, more precisely in its bottom third and fixes it there a further time. The air gap 6 between the outer shell 24 and the vessel shell 22 of storage vessel 16 is closed off against the surrounding area by the two sealing lips 66, 66′ at the top and at the bottom such that it is sturdy and its full, thermally insulating effect is developed.

Also shown in said figure is the addition of the further foodstuff 14. As the dimensions of the storage vessel 16 are chosen in size such that the ingredient 12 required for the preparation of the food preparation does not fill the entire interior 18, the remaining interior above the ingredient 12 can be used to receive and to mix the further foodstuff 14 with the ingredient 12. This latter can be effected by means of suitable cutlery or, as shown in FIG. 6, by the vessel system 10 being closed by way of the lid 38 and the ingredient 12 being mixed with the added, further foodstuff 14 by means of shaking (indicated by the double arrow e).

The lid 38 shown in FIG. 6 comprises a lid body 86 with a circumferential lid side 87 which stands out from the lid body 86. The lid side 87 is provided with one or multiple recesses 88 which, adapted to the configuration of the projection 9 of the outer shell 24, interact with said outer shell in the manner of a snap closure. The snap closure is preferably configured in such a manner that it acts as a seal at the same time and prevents liquid running out or spraying out during the shaking process. A sealing groove 90 can be provided in the lid as an option for receiving a seal 89 which, for example, interacts in a sealing manner with the widened end face 40 of the vessel shell 22 of the storage vessel 16. Depending on the material of the lid 86, the seal 89, however, can also be realized in one piece with the lid 86.

FIGS. 7 to 11 show further embodiments of the outer shell 24, in particular different configurations of the clamping element 28, in each case on the left-hand side of each figure the outer shell 24 being shown in a variant without a bottom and on the right-hand side being shown in a variant with a bottom 34. In FIG. 7, the clamping element 28 is composed of an upper, circumferential sealing lip 66 and clamping lugs 29 which protrude inward from the inside 30 of the outer shell 24. The clamping lugs 29, in the example shown here, have a rectangular or square outline and are distributed randomly both circumferentially and also axially beneath the sealing lip. The clamping lugs 29, however, can also have an arbitrary other outline. The embodiment in FIG. 8 differs from that in FIG. 7 in that the clamping lugs 29 comprise a round to circular outline and are arranged between an upper sealing lip and a lower sealing lip 66′. FIG. 9 shows an embodiment without sealing lips, which is why it only has clamping lugs 29 which are distributed randomly and circumferentially over the inside 30 of the outer shell 24. FIG. 10 shows an embodiment with clamping lugs 29 which are arranged circumferentially in an upper ring and a lower ring 67′, in each case uniformly distributed at the same height axially, and with further clamping lugs 29 which are distributed randomly over the inside 30 of the outer shell 24 between said rings 67, 67′. FIG. 11 shows an embodiment where the clamping element 28 includes only an upper ring 67 and a lower ring 67′ of clamping lugs 29 which are distributed circumferentially in a uniform manner. In addition, as indicated in the examples in FIGS. 12 and 13 (different embodiments are shown in each case on the right-hand side and on the left-hand side in said figures), both outer shell 24 and storage vessel 16 can be configured with and without shoulder 25 or vessel shoulder 23, and the storage vessel 16 can close off flush with the upper edge 36 of the outer shell 24 with its vessel edge 32 (cf. FIGS. 1, 2, 5, 6) or not. The individual elements of the examples shown can also be combined with one another in further variants and do not provide any definitive representation of the possible embodiments.

A further embodiment of the vessel system 10 is shown in FIGS. 14 to 17, different variants of said embodiment being shown again on the left-hand side and on the right-hand side in FIGS. 14 and 15. On the left-hand side, said embodiment is shown with an outer shell 24 which comprises a shoulder 25 but no bottom, whilst the embodiment on the right-hand side shows an outer shell 24 which, instead of the shoulder, comprises a changing angle of inclination of the shell at point 21 with reference to the longitudinal axis 11 and is provided with a bottom 34. In the embodiment shown here, on its upper edge 36 the outer shell 24 comprises a grip edge 37 which is formed as a shoulder and allows the vessel system 10 to be held comfortably, but also serves, when they are stacked inside one another (cf. FIG. 15), as a stack edge on which, in each case, an inserted outer shell rests on the outer shell situated below it.

In the case of the vessel system 10 shown in said figures, the storage vessel 16 is dimensioned in such a manner that, with the identical quantity of ingredient, it is filled to the top with the ingredient 12. It is, therefore, much smaller compared to the one shown in FIGS. 1, 2, 4, 5, 6. As can be seen from FIG. 16, storage vessels 16 in said configuration, when they have been closed with a lid foil 26, are stackable in a very space-saving manner. The same applies as described above in conjunction with FIGS. 1 and 4, including all variation possibilities which are produced from said configuration forms, with reference to the lid foil 26, to its application and to the upper vessel edge of the storage vessel 16 with widening 8 or flange 7.

As can be seen from FIG. 14, in the case of such a configuration of the storage vessel 16, the outer shell 24 is configured in such a manner that the shell height ha of the outer shell 24 is much greater than the height hg of the vessel shell of the storage vessel 16. The storage vessel 16 is inserted deeply into the outer shell 24 such that above the storage vessel 16, the outer shell 24 surrounds a space 19 which, in the case of said variant of the vessel system 10, serves for receiving the further foodstuff 14 and for mixing the further foodstuff 14 with the ingredient 12 (cf. FIGS. 23-25). The clamping element 28 of the outer shell 24 can be configured once again in the form of clamping lugs 29 (see left-hand side of FIGS. 14 and 15) or in the form of a sealing lip 66 (see right-hand side of FIG. 14) or of multiple sealing lips 66, 66′ (see FIG. 17: storage vessel 16 not yet inserted completely into the outer shell 24).

In the variant of said embodiment shown on the right-hand side of FIG. 14, the clamping element 28 is realized in the form of a sealing lip 66 in such a manner that, in the combined state, the storage vessel 16 is clamped and fixed in the manner of a type of snap mechanism beneath the sealing lip 66 between sealing lip 66 and bottom 34. At the same time, the clamping element 28, in the form of the sealing lip 66, seals the air gap 6 upward between vessel wall 22 and outer shell 24 such that it can develop its thermally insulating effect fully and is stable and, in addition, nothing—nothing from the ingredient 12 but also nothing from the further foodstuff 14 (for example during the mixing process)—can pass into the air gap 6.

Instead of clamping the storage vessel 16 between bottom and sealing lip or a number of clamping lugs arranged circumferentially in a ring-shaped manner, it is also conceivable for the storage vessel 16 to be clamped between sealing lip or a number of clamping lugs arranged circumferentially in a ring-shaped manner and the shoulder 25, as is shown as an example in FIG. 22. In such a case, the configuration of the outer shell 24 with a bottom is an option and not necessary. FIG. 22 shows such an embodiment of the outer shell 24 consequently without a bottom and FIG. 23 shows it with a bottom 34, that is to say in the sense of an outer container 24′.

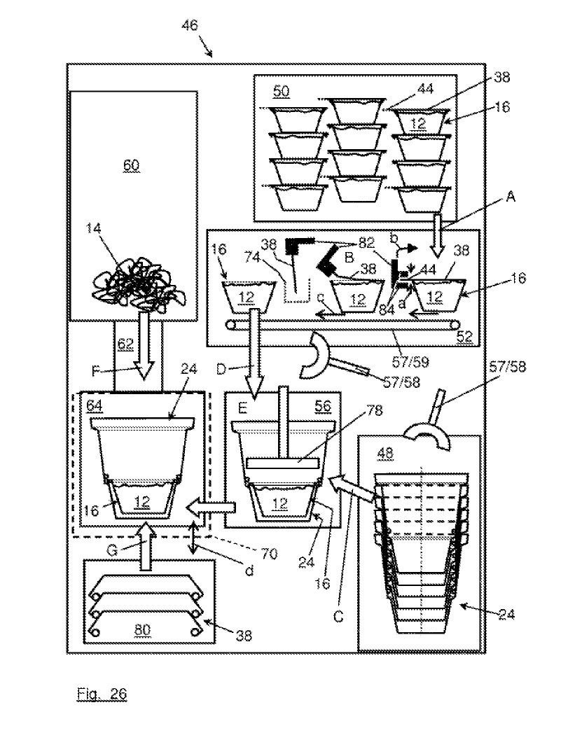

If the open storage container 16 is fixed in the described manner in the outer shell 24, the vessel system 10 can be filled with a further foodstuff 14 as indicated in FIG. 23. In order to keep ingredient 12 and foodstuff 14 temperate, that is to say warm or hot, or very cold, said embodiment of the vessel system 10 is also closable with a lid 38 and openable again, as shown in FIGS. 24, 25. The lid 38 is realized in a manner adapted to the embodiment of the vessel system with a lid body 86, a lid side 87 which protrudes from the lid body 86—preferably perpendicularly or at an angle of between 80° and approximately 110°—and a lid flange 91 which protrudes radially inward from the lid side 87 in particular at an obtuse angle and interacts in the manner of a snap mechanism with the grip edge 37. In an advantageous manner, the lid flange 91 is realized circumferentially in such a manner that it interacts sealingly with the grip edge 37.

In a particularly environmentally friendly variant, the storage vessel 16 and the outer shell 24 are easy to recycle or re-use, they can also be separated from one another by hand. The outer shell 24 comprises, for this purpose, either no bottom, such that the storage vessel 16 can be pressed upward out of the outer shell 24 simply by pressure onto the vessel bottom 20 (arrow f in FIG. 22), or the bottom 34 is formed in such a flexible manner that it is pressable from the outside against the vessel bottom 20 of the storage vessel 16 with the same effect (arrow f in FIG. 25). The snap mechanism, by way of which the storage vessel 16 has been pressed into the outer shell 24 below the ring of clamping lugs or the circumferential sealing lip and has been fixed in it, has to be overcome in the opposite direction in this case. If the outer shell 24 is an outer container 24′ with a bottom 34 and if the air gap 6 between outer shell 24 and storage vessel 16 is closed upward by a sealing lip 66, the compressing of the air enclosed in the air gap 6, when pressing against the bottom 34, helps in a supporting manner in order to overcome the resistance of the snap mechanism in said reversed direction.

The use of the vessel system 10 is subsequently explained by way of FIGS. 18 to 25 and at the same time the principle design of an automatic machine, in which the vessel system 10 according to the invention is used, is explained by way of FIG. 26.

First of all, corresponding to the choice of a user, a storage vessel 16 with the chosen ingredient, for example from a storage unit 50 with multiple storage vessels 16 stored therein, is separated out (arrow A) and opened B. This can be effected, for example, in a device for separating-out and opening 52. Possible variants of the opening are explained further below by way of FIGS. 18 and 19. At the same time, for example, one outer shell 24 is separated out from a depot 48 in which a number of outer shells 24 are stored, in particular are stacked inside one another, and, for example, is transferred (arrow C) into a combining station 56 by way of a transport device 57. The open storage vessel 16 is also transferred into the combining station 56 by means of a transport device 57. As shown in FIG. 26, the transport device can be realized in the form of a gripper 58 or a conveyor belt 59, etc.

In the combining station 56, storage vessels 16 are placed E in the outer shell 24 to form the vessel system 10 according to the invention or a dispensing container 10′ according to the invention. In said example, the storage vessel 16 is pressed into the outer shell 24 by way of a punch 78 such that the storage vessel 16 snaps under the clamping element 28 realized as a sealing lip 66 and is clamped by the sealing lip 66 between bottom 34 and sealing lip 66 (cf. FIGS. 20-22 also in this respect). In a foodstuff unit 60, the further foodstuff 14 is meanwhile prepared for delivery F into the vessel system 10. The preparation can include, for example, making available one foodstuff 14, which can be chosen from multiple foodstuffs, and/or also tempering, that is to say cooling down or heating up or even freshly cooking (cf. for example EP 2 316 308) said foodstuff 14. This can also occur either in the combining station 56 or in a further station or, as shown in FIG. 26, once the vessel system 10 has been transferred into a dispensing compartment 64. If the ingredient 12 and the further foodstuff 14 are situated in the vessel system 10 (cf. also FIGS. 23, 24), everything can be removed together from the dispensing compartment 64 by the user and the vessel system 10 serves as a dispensing container 10′.

As an option, as is shown in FIG. 24, a store 80 for lids 38 can be provided. In this case, a lid 38 is made available to the user from said store as an option as required or also automatically or, the dispensing container 10′ is automatically closed with a lid 38 prior to dispensing the dispensing container 10′ to the user (cf. FIG. 24). In the last-named case, shaking, which is carried out as required or automatically, is also an option (FIG. 24 arrow e) such that the user obtains ingredient 12 and foodstuff 14 already mixed together. The user then only has to open the lid (FIG. 25) and can start to eat.

The dispensing compartment 64 can be provided with a compartment door 70 as an option. Said compartment door can be either opened or closed at any time by hand. However, it is also conceivable for the compartment door 70—in particular when the dispensing compartment 60 does not serve only for dispensing the dispensing container 10′ but also for other further functions (for example adding the further foodstuff 14, the lid 38 and/or shaking)—to be controlled in such a manner that it can only be opened or only opens automatically when all operations have been concluded. Correspondingly, the compartment door 70 is then automatically closed and locked, where applicable once the dispensing container 10′ has been removed.

FIGS. 18 and 19 show two examples of how a storage vessel 16, which is closed with a lid foil 26, can be opened.

FIG. 18 shows a storage vessel 16 with a lid foil 26 with a circumferential grip edge 44′ which protrudes radially outward. The storage vessel 16 is moved in the direction of the arrow c such that the grip edge 44′ is inserted between two clamping jaws 84 of a gripper 82. The clamping jaws 84 of the gripper 82 close (small arrow a) and clamp the grip edge 44′ of the lid foil 26. If the lid foil 26 of a storage vessel 16 is provided with a grip tab 44 which only protrudes in a small circumferential region, the storage vessel 16 has to be moved toward the gripper 82 correspondingly aligned so that the gripper 82 is also able to hold the grip tab 44. The storage vessel 16 is moved further in direction c and the gripper is moved upward, for example, in an arcuate manner, the alignment of the gripper 82 or of its clamping jaws 84 being altered advantageously at the same time by, for example, 90°. As a result of the described sequences, the lid foil 26 is pulled away from the storage vessel 16 and the storage vessel 16 is opened. It is naturally also conceivable for the storage vessel to be stationary when the gripper removes the lid foil or for the gripper only to be moved out of the path of movement of the storage vessel 16 and opening to be effected purely on account of the movement of the storage vessel 16 in the direction of arrow c and other variants. As an option, the gripper 82 can be moved even further (arrow c′), for example over a disposal bin 74 (cf. FIG. 26). The clamping jaws open and allow the lid foil 26 to drop into the disposal bin 74.

FIG. 19 shows a storage vessel 16 with a lid foil 26, the edges of which are bent around and therefore do not provide a gripper with any access possibility. In such a case, the lid foil can be opened, for example, with a cutter 92 which is guided similarly to a can opener in a circle or along the contour of the storage vessel 16 (arrow k), it naturally also being possible, instead of this or in addition to it (in the opposite direction in this case), to move the storage vessel 16 in a corresponding manner (arrow k′). The movement, in this case, is thus preferably carried out such that the lid foil 26 is separated for instance along the inner edge of the storage vessel 16. Punching out an analogous part of the lid foil by means of a punching blade is also conceivable. The separated part of the lid foil can be lifted (arrow m) by means of a lifting mechanism 94, which, for example, operates with negative pressure and sucks up the lid foil.

As has been able to be shown by means of said embodiment, it is possible by means of the vessel system according to the invention to provide freshly prepared, ready-made food preparations, which include at least one foodstuff which is present in the form of an ingredient and one further foodstuff, in a fully automatic machine in a hygienic, appetizing and convenient manner for the user, the food preparations being served insulated thermally from the outside and the hands of the user being protected from the temperature of the food preparation as a result of the special type of vessel system. At the same time, the components can be stored in a space-saving manner in the automatic machine and can be separated from one another again, when required, for re-use and/or recycling.

It is clear to the expert that and in what manner the embodiments described, or the details described by way of the exemplary embodiments can be combined in a sensible manner. For reasons of space, it is not possible, however, to represent figuratively and/or to describe all the possible and sensible combinations in detail.

1. A vessel system for storing an ingredient and subsequent dispensing of said ingredient together with further, heated or cooled foodstuffs to a user, including
an inner vessel with a fillable interior and
an outer shell which is realized in such a manner to receive the inner vessel that it insulates the contents of the inner vessel thermally from the outside, wherein
outer shell and inner vessel are tapered downward, that is to say in the direction of the vessel bottom of the inner vessel,
outer shell and inner vessel are separate elements which can be put together to form a dispensing container, wherein
the fillable interior of the inner vessel is sealingly closable with a lid foil in such a manner that the inner vessel forms a tightly closable storage vessel for the storage of the ingredient and multiple storage vessels are stackable by placing them one on top of another, and
the outer shell comprises a radially inwardly projecting clamping element for the fixing of the storage vessel inserted into the outer shell, wherein the outer shell is configured tapering downward in such a manner that multiple outer shells are stackable nested inside one another.

2. The vessel system as claimed in claim 1, wherein the storage vessel comprises a vessel bottom and a vessel shell which protrudes from the vessel bottom and has a height, wherein the at least one clamping element projects inward from an inside of the outer shell matched in such a manner to the height (hg) of the vessel shell of the storage vessel that, when the storage vessel is received in the outer shell, it fixes the storage vessel in the outer shell by cooperating in a clamping manner with the storage vessel in the top third of its vessel shell or by projecting radially inward beyond an upper vessel shell edge of the storage vessel above the storage vessel, and in particular interacting in the form of a snap mechanism with the vessel shell edge.

3. The vessel system as claimed in claim 1, wherein the clamping element of the outer shell is realized in the form of one or multiple circumferential sealing lips and/or in the form of clamping lugs.

4. The vessel system as claimed in claim 1, wherein outer shell and storage vessel are tapered matched to one another in such a manner that there is an air gap between outer shell and storage vessel in the put-together state, wherein the air gap is preferably stabilized by the clamping element.

5. The vessel system as claimed in claim 1, wherein the outer shell projects beyond a vessel shell of the storage vessel beyond its vessel shell height and thus forms a space above the storage vessel in the put-together state of the vessel system, wherein the storage vessel is preferably dimensioned in a small manner such that, in the filled state, it is filled with the ingredient up to its upper edge.

6. The vessel system as claimed in claim 1, wherein
the outer shell is provided with a bottom and consequently forms an outer container which surrounds the storage vessel at the bottom and all around the outside of its vessel shell,
and preferably thus forming a thermally insulating air gap, wherein in particular
the bottom of the outer container is configured such that it is pushable toward an inside of the outer container in a reversible manner and it is pressable against the vessel bottom of the storage vessel such that the storage vessel is movable out of the outer container by means of said pressure.

7. The vessel system as claimed in claim 1, wherein a removable lid is provided, by which removable lid the vessel system is closable—in particular in a sealing manner, wherein the outer shell is preferably configured at its upper edge in such a manner that it is enabled to interact sealingly with the lid.

8. The vessel system as claimed in claim 1, wherein the vessel shell of the storage vessel comprises an application surface on its end face for the application of the lid foil and the lid foil comprises in particular a grip tab which protrudes radially outward beyond the vessel shell or a grip edge which protrudes radially outward and wherein the lid foil is applicable preferably by means of bonding or welding or sealing.

9. The vessel system as claimed in claim 1, wherein the outer shell is configured in such a manner that multiple outer shells are stackable nested inside one another, in particular without being clamped by the at least one clamping element of the respectively receiving outer shell.

10. An automatic machine for dispensing to a user a food preparation having a foodstuff unit in which at least one foodstuff is held in stock and where applicable is freshly prepared, wherein
the food preparation is providable in a vessel system as claimed in any one of the preceding claims and the food preparation includes at least the one further foodstuff and an ingredient provided in a storage vessel, wherein the automatic machine includes the following components:
a storage unit for holding in stock a number of storage vessels filled with ingredients and closed with lid foils,
a depot for holding in stock a number of outer shells stacked inside one another,
a device for separating-out and opening a selected storage vessel,
a device for separating-out an outer shell from the stack of outer shells held in stock in the Depot,
a combining station in which one opened storage vessel each is insertable into a separated-out outer shell, as a result of which a dispensing container is formable,
a feeding device by means of which the at least one further foodstuff is feedable to the dispensing container with the ingredient located therein.

11. The automatic machine as claimed in claim 10, wherein a dispensing compartment is provided for dispensing the dispensing container, which is filled with ingredient and further foodstuff and preferably is secured from the user by way of a compartment door, which is controllable automatically at least with reference to its locking, wherein the combining station, in particular, serves as a dispensing compartment at the same time.

12. The automatic machine as claimed in claim 10, wherein the combining station includes a punch-like element, by way of which the storage vessel is placeable in the outer shell in a precise fitting manner and where applicable against the resistance of the clamping element, wherein the outer shell is holdable in position in particular by means of a holder of the combining station.

13. The automatic machine as claimed in claim 10, wherein a store for lids, a device for dispensing a lid and/or for closing the dispensing container with a lid as well as a shaking device are provided.

14. A method for dispensing to a user a freshly composed food preparation comprising at least one foodstuff in the form of an ingredient and one further foodstuff, characterized in that the food preparation is provided in a vessel system as claimed in claim 1, wherein a dispensing container is formed from an outer shell and a storage vessel of the vessel system.

15. The method according to claim 14, wherein
a) one ingredient is chosen from various ingredients,
b) one storage vessel with the chosen ingredient is separated-out from a number of storage vessels with different ingredients and is opened,
c) one outer shell is separated-out from a number of outer shells,
d) the separated-out outer shell and the opened storage vessel are brought together to form the dispensing container,
e) the further foodstuff is prepared and once the preparation has been completed is output into the dispensing container,
f) the dispensing container with the ingredient and the further foodstuff is dispensed to the user.

16. The method as claimed in claim 14, wherein ingredient and further foodstuff are mixed in the dispensing container, before the dispensing container is dispensed to the user and wherein the mixing is effected in particular as a result of shaking and the dispensing container is closed with a lid prior to the shaking.
